(19) United States
(12) Patent Application Publication
(10) Pub. No.: US 2002/0180907 A1
(43) Pub. Date: Dec. 5, 2002

(54) Liquid crystal display with improved light diffuser

(75) Inventors: Norihiro Imamura, Kyoto (JP); Hisayoshi Fujimoto, Kyoto (JP); Toshihiko Takakura, Kyoto (JP)

Correspondence Address: MERCHANT & GOULD PC, P.O. BOX 2903, MINNEAPOLIS, MN, 55402-0903, US

(73) Assignee: ROHM CO., LTD., KYOTO-SHI (JP)

(21) Appl. No.: 10/134,322

(22) Filed: Apr. 29, 2002

(30) Foreign Application Priority Data
May 1, 2001 (JP) 2001-134055
Aug. 24, 2001 (JP) 2001-255092
Nov. 1, 2001 (JP) 2001-336486

(51) Int. Cl. G02F 1/1335

(52) U.S. Cl. 349/112

(57) ABSTRACT

A liquid crystal display includes a liquid crystal layer, a holding assembly for internally holding the liquid crystal layer, and a diffusion mollifying layer that reduces the diffusion of light entering into the assembly. The holding assembly includes a plate having a rugged surface resulting from a surface-roughening process. The rugged surface is covered by the diffusion mollifying layer to reduce the frequency of light diffusion.

### BACKGROUND OF THE INVENTION

1. Field of the Invention

The present invention relates to a reflective-type or transflective-type liquid crystal display (LCD).

2. Description of the Related Art

As is known, liquid crystal displays (LCDs) are classified into three different types depending upon their illumination methods. They are reflective-type, transflective-type and transmissive-type. Of these, the reflective-type and the transflective-type are advantageous in saving power over the transmissive-type because in the former two types, ambient light (such as indoor illumination and sun light) can be utilized for image display, while in the latter type, such light cannot be used.

Generally, a typical reflective-type LCD includes a LC panel and a polarizing plate disposed in front of the LC panel. Specifically, the LC panel may a transparent first substrate, a second substrate facing the first substrate, and a liquid crystal layer contained between the first and the second substrates. Further, the reflective-type LCD may include a reflective plate disposed in back of the second substrate (or reflective electrodes disposed in front of the second substrate). In this arrangement, the ambient light passes through the polarizing plate, the first substrate and the LC layer, and then is reflected forward by the reflective plate to the viewer for image display.

In such a reflective-type LCD, the reflective rear plate is often subjected to surface roughening (by sand-blasting for example), thereby providing a rugged reflective surface. The ambient light, entering into the LCD, is reflected on this rugged surface and diffused. This light diffusion is caused to occur in expectation of making the viewing area bright and providing good viewability.

However, the reflective surface of the conventional reflective plate is extremely rugged, so that the vibrating direction of the polarized light is unduly changed when the light is reflected on the reflective plate. Consequently, the polarized state of the light deteriorates, thereby resulting in drawbacks such a poor contrast of displayed images.

### SUMMARY OF THE INVENTION

The present invention has been proposed under the circumstances described above. It is, therefore, an object of the present invention to provide a liquid crystal display with an improved light diffuser which can diffuse light to an appropriate degree. Another object of the present invention is to provide a method of making such an advantageous light diffuser for use in an LCD.

According to a first aspect of the present invention, there is provided a liquid crystal display that includes: a liquid crystal layer; a holding assembly including at least one plate for internally holding the liquid crystal layer; and a diffusion mollifying layer that reduces diffusion of light entering into the assembly. The above-mentioned plate includes a rugged surface resulting from surface roughening, and the rugged surface is covered by the diffusion mollifying layer.

The surface roughening may be performed by a blasting process or etching process.

Preferably, the diffusion mollifying layer may include a non-flat surface that is smoother than the rugged surface of the above-mentioned plate. The diffusion mollifying layer may be made of resin.

Preferably, the holding assembly may include a transparent front panel, and the liquid crystal layer may be disposed between the front panel and the above-mentioned plate. In this case, the plate may be made of soda glass, while the diffusion mollifying layer may be made of silicon dioxide.

Preferably, the LC display of the present invention may further include a polarizer disposed in front of the front panel.

Preferably, the LC display of the present invention may further include a metal layer formed on the non-flat surface of the diffusion mollifying layer.

Preferably, the metal layer may include a non-flat reflective surface.

Preferably, the LC display of the present invention may further include a polarizer. The above-mention plate and the diffusion mollifying layer may be disposed between the polarizer and the liquid crystal layer.

Preferably, the holding assembly may include a reflecting surface that causes light passing through the liquid crystal layer to be reflected toward the above-mentioned plate.

Preferably, the diffusion mollifying layer may allow the passage of ambient light entering into the assembly and the passage of light reflected by the above-mentioned reflecting surface.

Preferably, the diffusion mollifying layer may be held in contact with the polarizer.

Preferably, the LC display of the present invention may further include a front glass panel disposed between the diffusion mollifying layer and the liquid crystal layer. The front glass panel may be held in contact with the diffusion mollifying layer.

According to a second aspect of the present invention, there is provided a method of making a light diffusion assembly used for a liquid crystal display. The method includes the steps of: subjecting a base member to surface roughening for providing the base member with a rugged surface; and forming a coating layer on the rugged surface in a manner such that the coating layer is provided with a non-flat surface. The rugged surface of the base member may result from a blasting process or etching process. The coating layer may be formed by applying resin onto the rugged surface of the base member by a spin coat method.

Other features and advantages of the present invention will become apparent from the detailed description given below with reference to the accompanying drawings.

### BRIEF DESCRIPTION OF THE DRAWINGS

FIG. 1 is a sectional view showing the basic structure of a liquid crystal display according to a first embodiment of the present invention;

FIG. 2 is a perspective view showing first and second substrates used for the LCD of FIG. 1;

FIGS. 3A˜3C illustrate how reflective electrodes are formed on the second substrate;

FIG. 4 is a sectional view showing the basic structure of a liquid crystal display according to a second embodiment of the present invention;

FIG. 5 is a sectional view showing the basic structure of a liquid crystal display according to a third embodiment of the present invention;

FIG. 6 is a sectional view showing the basic structure of a liquid crystal display according to a fourth embodiment of the present invention;

FIG. 7 illustrates how the ambient light passes through the light diffusion assembly of the LCD shown in FIG. 6; and

FIG. 8 is a sectional view showing the basic structure of a liquid crystal display according to a fifth embodiment of the present invention.

### DETAILED DESCRIPTION OF THE PREFERRED EMBODIMENTS

Preferred embodiments of the present invention will be described below with reference to the accompanying drawings.

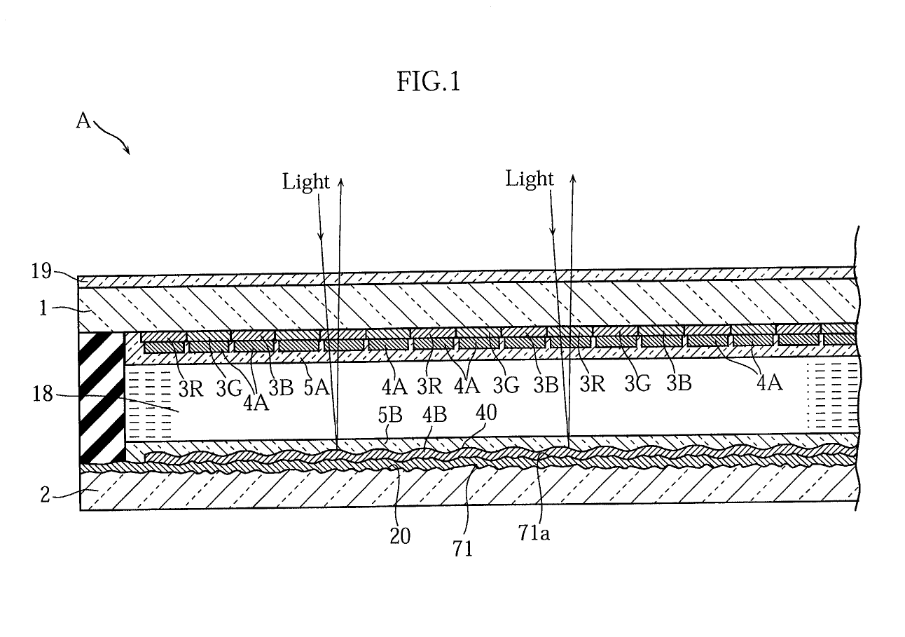

FIG. 1 shows the basic structure of a liquid crystal display (LCD) according to a first embodiment of the present invention. As illustrated, the LCD A is of a reflective-type, including a first substrate 1, a second substrate 2 (spaced from and parallel to the first substrate 1), liquid crystal 18 (contained between the first and the second substrates), a plurality of transparent electrodes 4A and a plurality of reflective electrodes 4B.

The first and the second substrates 1, 2 may be made of glass or acrylic resin. The first substrate 1 is transparent, while the second substrate 2 may be transparent or not. A polarizing plate 19 is attached to the upper surface (front surface) of the first substrate 1, thereby causing light waves vibrating only in a prescribed direction to pass through.

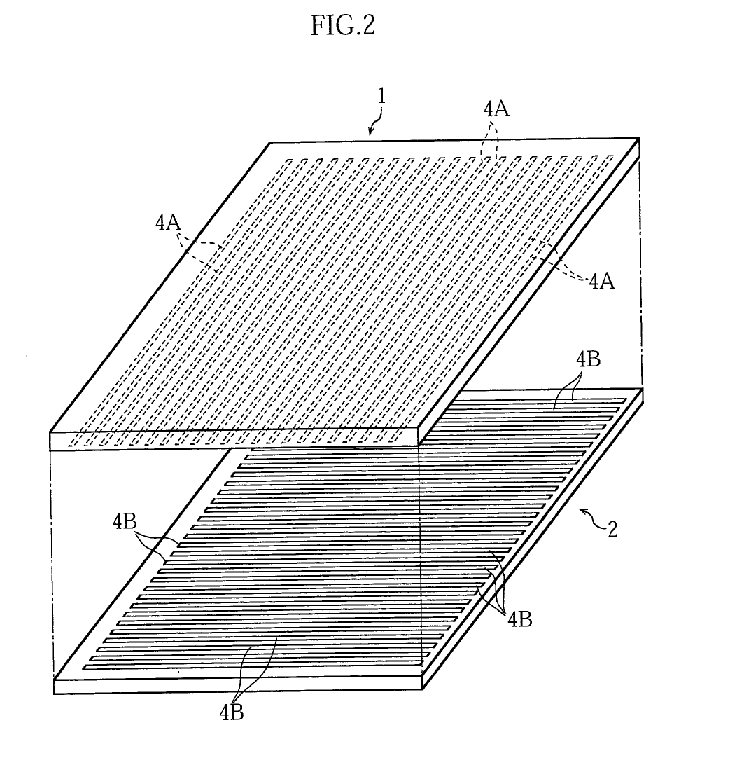

The transparent electrodes 4A may be made of indium tin oxide (ITO) and arranged on the lower side of the first substrate 1. In the illustrated embodiment, three kinds of color filters 3R(red), 3G(green) and 3B(blue) are provided between the electrodes 4A and the substrate 1. FIG. 1 depicts the electrodes 4A as being directly formed on the color filters 3R, 3G and 3B. Preferably, the lower surface of the respective filters 3R, 3G and 3B may be formed with a transparent layer of silicon oxide upon which an transparent electrode 4A is formed. The LCD A may operate by simple matrix driving method. As shown in FIG. 2, the parallel, strip-like electrodes 4A are regularly distanced from each other.

The reflective electrodes 4B are disposed on the upper side of the second substrate 2 and have a strip-like configuration, as shown in FIG. 2, like the transparent electrodes 4A. The reflective electrodes 4B and the transparent electrodes 4A are elongated perpendicularly to each other. Each intersection of the electrodes 4A and 4B corresponds to one dot to which required voltage is applied selectively. The combination of three dots (red, green and blue dots) provides one pixel for color display. The transparent electrodes 4A and the reflective electrodes 4B are coated by alignment layers 5A and 5B, respectively, for twisting the molecules of the liquid crystal, as required. The liquid crystal may be nematic one, though the present invention is not limited to this.

The reflective electrodes 4B, which may be made of aluminum, have a light-reflecting surface 40. The second substrate 2 has an upper surface 20 which has been made rugged by abrasive blasting for example. The rugged surface 20 is covered by a coating layer (diffusion mollifying layer) 71. The above-mentioned reflective electrodes 4B are formed on this coating layer 71.

The rugged surface 20 of the second substrate 2 has a roughness of about 0.05 μm (center line average or CLA) The coating layer 71 is also rugged and has a thickness of about 0.1 μm. The roughness of the layer's surface 71 is about 0.02 μm (CLA). The coating layer 71 may be made of polyimide or acrylic resin. The reflective electrodes 4B are made from a metal layer of a generally constant thickness that is formed on the surface 71a of the coating layer 71. Thus, the surface 40 of each reflective electrode 4B has generally the same roughness as the surface 71a of the coating layer 71. In the illustrated embodiment, the exposed portions of the surface 71a of the coating layer 71 (i.e., the portions that are not covered by the reflective electrodes 4B) are reflective as in the electrodes 4B. Though the coating layer 71 can be transparent and still reflect light, it may preferably be non-transparent (white for example) for better light reflection.

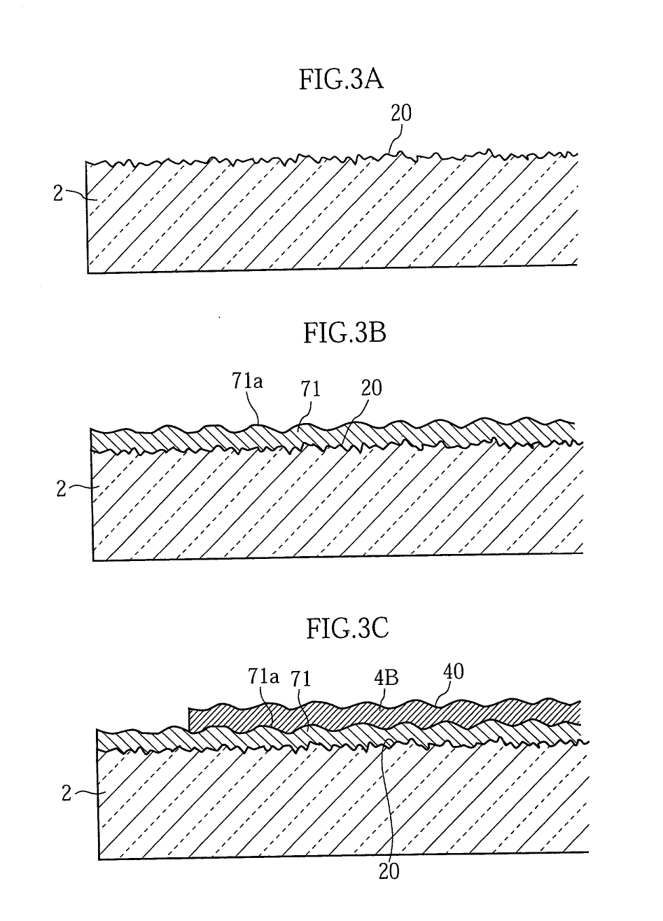

The reflective electrodes 4B may be formed by a process shown in FIGS. 3A˜3C. First, the second substrate 2 is subjected to sand-blasting so that, as shown in FIG. 3A, the selected surface 20 becomes rugged. Then, as shown in FIG. 3B, a coating layer 71 is formed on the rugged surface 20 by e.g. a known spin-coating method using a resin material in a molten state. Then, a metal layer (e.g. aluminum layer) is formed, by vapor deposition or sputtering for example, on the solidified coating layer 71. Finally, the obtained metal layer is subjected to etching to provide the desired reflective electrodes 4B, as shown in FIG. 3C.

According to the above process, the surface 71a of the coating layer 71 is made less rugged than that of the second substrate 2, as seen from FIG. 3B, so that the surface 71a undulates smoothly. Also, the reflective electrodes 4B, which are formed on this smooth undulating surface 71a, have a smooth undulating surface 40.

The image-displaying mechanism of the LCD A is basically the same as that of a conventional reflective-type LCD. Specifically, referring to FIG. 1, the ambient light passes through the polarizing plate 19, the first substrate 1 and the liquid crystal 18. Then, the light is reflected back by the reflective electrodes 4B to the viewer. In the illustrated embodiment, as noted above, light reflection also occurs on the surface 71a of the coating layer 71. This is advantageous to brightening the viewing area of the LCD and providing enhanced contrast.

According to the above embodiment, the smooth undulating surfaces of the reflective electrodes 4B and coating layer 71 reflect the penetrating ambient light. Advantageously, these smooth surfaces will scatter or diffuse light to a smaller degree than the raw sand-blasted surface 20 (see FIG. 3A). Thus, the polarization of the reflected light is so maintained as to provide good contrast. Further, since light-scattering is not totally prohibited in the LCD A, the viewing area of the display can be made bright enough to prevent an ambient object (such as a fluorescent lamp on the ceiling) from being mirrored on the display.

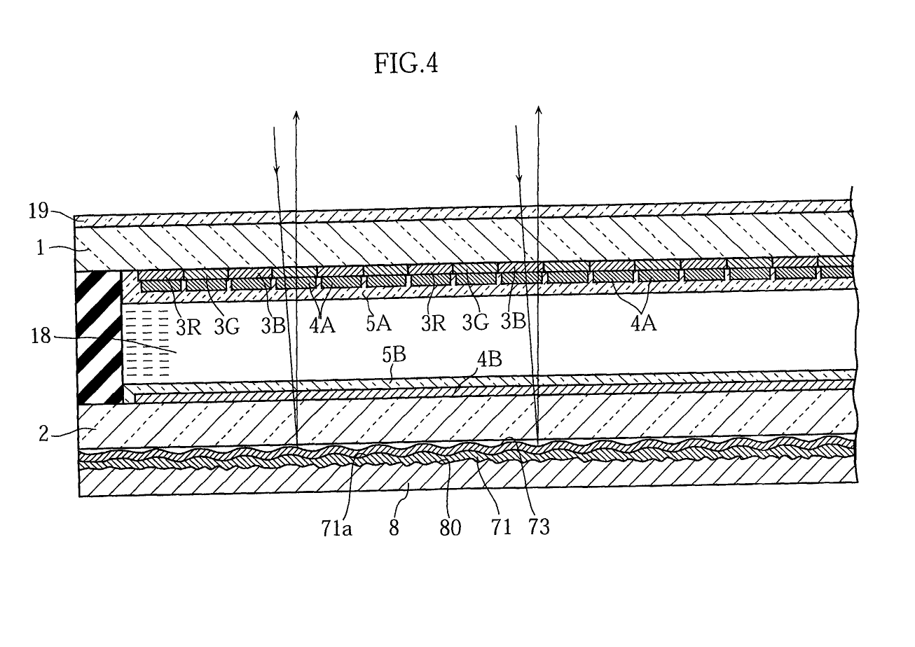

FIGS. 4˜8 illustrate other embodiments of the present invention. Though these figures, elements that are identical or similar to those shown in FIG. 1 are indicated by the same reference signs.

In the structure shown in FIG. 4, a reflective plate 8 is attached to the back side of the second substrate 2. The reflective plate 8, made of e.g. synthetic resin, has its upper side subjected to sand-blasting so that the surface 80 is rugged. On the surface 80 are formed a coating layer 71 and a metal layer 73 that covers the entire surface of the coating layer 71. The upper surface of the metal layer 73 is a reflective surface. Like the surface 71a of the coating layer 71, the upper surface of the metal layer 73 is a smoothly curved uneven surface. A plurality of transparent electrodes 4B are formed on the second substrate 2. The ambient light penetrating the LCD passes through the electrodes 4B to strike upon the metal layer 73. Alternatively, the electrodes 4B may be made of a non-transparent reflective material. In this case, the ambient light is partly reflected by the electrodes 4B and partly passes between the electrodes 4B to reach the metal layer 73.

With the structure shown in FIG. 4, the ambient light penetrating the LCD is scattered by the metal layer 73. This scattering of light provides the same advantageous effects as in the above-described first embodiment, where light is scattered by the reflective electrodes 4B.

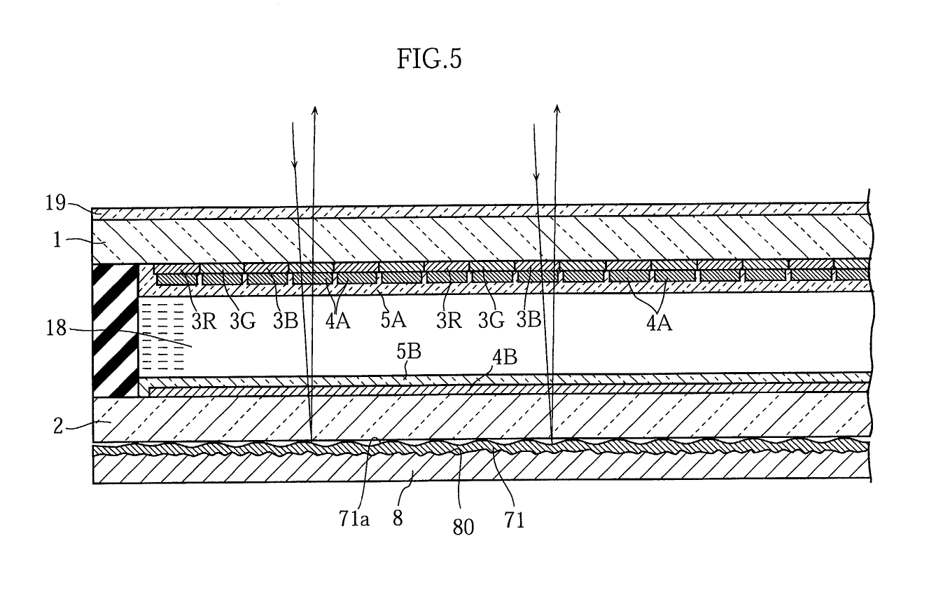

In accordance with the structure shown in FIG. 5, a coating layer 71 is formed on an uneven surface 80 of a reflective plate 8, but no metal layer is formed on the coating layer 71. Instead, the coating layer 71 has a reflective surface 71a for scattering light. For good reflectivity, the coating layer 71 may be made of a white resin material.

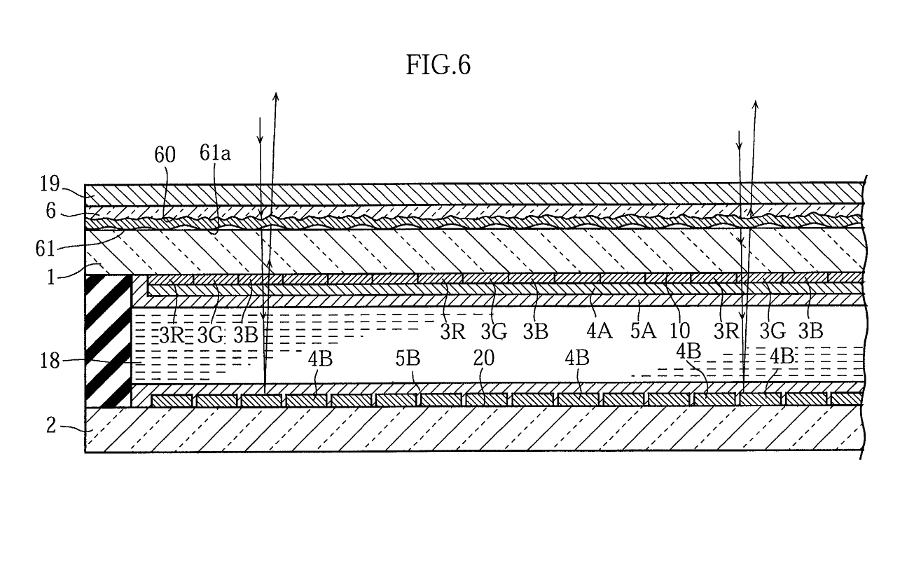

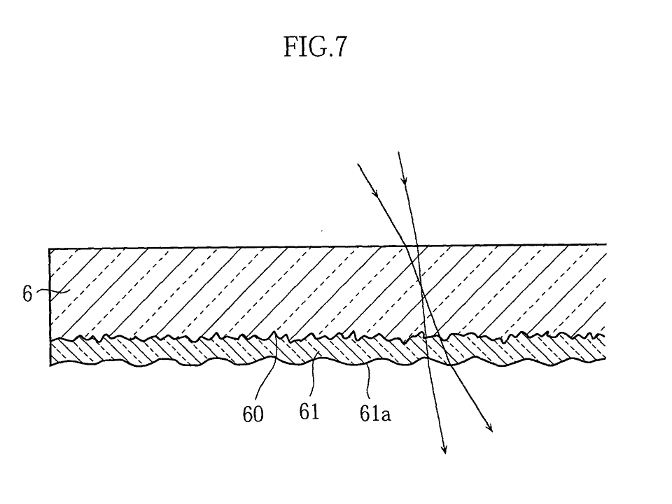

In accordance with the structure shown in FIG. 6, a light-permeable member 6 is provided between a first substrate 1 and a polarizing plate 19. As best shown in FIG. 7, the lower surface 60 of the light-permeable member 6 is a sand-blasted, rugged surface. On this rugged surface 60 is formed a coating layer (diffusion mollifying layer) 61. The surface 60 and the coating layer 61 are the same in surface roughness as the rugged surface 20 and the coating layer 71 of the previous embodiment. Further, the surface 60 and the coating layer 61 may be formed in the same manner as the rugged surface 20 and the coating layer 71. The coating layer 61 has a smooth undulating surface 61a. The coating layer 61 allows the passage of light and has a refractive index which is generally equal to that of the first substrate 1.

With the above arrangement, the ambient light passes through the polarizing plate 19, the light-permeating member 6 and the coating layer 61. As seen from FIG. 6, the coating layer 61 has an undulating surface 61a from which the passing light is emitted. Due to the undulation of the surface 61a, the light is scattered as being emitted from the surface 61a toward the first substrate 1. The advantageous effects of this scattering of light are the same as those enjoyable in the above-described embodiments.

The coating layer 61 may be attached to the upper side of the light-permeating member 6. In this case, the upper surface of the light-permeating member 6 is subjected to e.g. sand-blasting before the coating layer 61 is fixed to the member 6. As a third option, both the upper and the lower sides of the light-permeating member 6 may be covered by a coating layer.

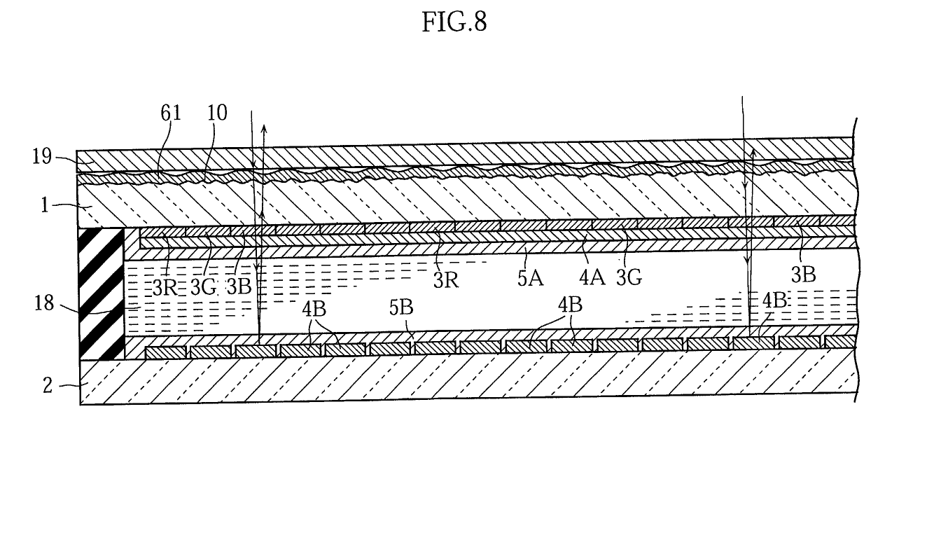

In accordance with the structure shown in FIG. 8, the upper surface 10 of a first substrate 1 is subjected to sand-blasting, to provide a rugged surface. A transparent coating layer 61 is formed directly on the rugged surface 10.

According to the present invention, the first and/or the second substrates may be made of soda glass. In this case, the substrate is subjected to surface roughening by a sand-blasting method for example, and then the obtained rugged surface of the substrate may be coated with a silicon oxide layer formed by a dip coating method. Since soda glass is not an expensive material, the production cost of an LCD employing soda glass substrates is advantageously reduced. The silicon oxide coating contributes to preventing the precipitation of alkali from the soda glass.

According to the present invention, the surface roughening may be performed by a blasting process, an etching process, etc. For instance, when the first or second substrate is made of soda glass, the substrate may be dipped into an etchant of hydrofluoric acid, to provide the required rugged surface.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A liquid crystal display comprising:
a liquid crystal layer;
a holding assembly including at least one plate for internally holding the liquid crystal layer; and
a diffusion mollifying layer that reduces diffusion of light entering into the assembly;
wherein said plate includes a rugged surface resulting from surface roughening, the rugged surface being covered by the diffusion mollifying layer.

2. The display according to claim 1, wherein the diffusion mollifying layer includes a non-flat surface that is smoother than the rugged surface of said plate.

3. The display according to claim 1, wherein the diffusion mollifying layer is made of resin.

4. The display according to claim 1, wherein the assembly includes a transparent front panel, the liquid crystal layer being disposed between the front panel and said plate.

5. The display according to claim 4, wherein said plate is made of soda glass, the diffusion mollifying layer being made of silicon dioxide.

6. The display according to claim 4, further comprising a polarizer disposed in front of the front panel.

7. The display according to claim 1, wherein the rugged surface of said plate results from one of a blasting process and an etching process.

8. The display according to claim 2, further comprising a metal layer formed on the non-flat surface of the diffusion mollifying layer.

9. The display according to claim 8, wherein the metal layer includes a non-flat reflective surface.

10. The display according to claim 1, further comprising a polarizer, wherein said plate and the diffusion mollifying layer are disposed between the polarizer and the liquid crystal layer.

11. The display according to claim 10, wherein the assembly includes a reflecting surface that causes light passing through the liquid crystal layer to be reflected toward said plate.

12. The display according to claim 11, wherein the diffusion mollifying layer allows passage of ambient light entering into the assembly and passage of light reflected by said reflecting surface.

13. The display according to claim 10, wherein the diffusion mollifying layer is held in contact with the polarizer.

14. The display according to claim 10, further comprising a front glass panel disposed between the diffusion mollifying layer and the liquid crystal layer, wherein the front glass panel is held in contact with the diffusion mollifying layer.

15. A method of making a light diffusion assembly used for a liquid crystal display, the method comprising the steps of:
subjecting a base member to surface roughening for providing the base member with a rugged surface; and
forming a coating layer on the rugged surface in a manner such that the coating layer is provided with a non-flat surface.

16. The method according to claim 15, wherein the rugged surface of the base member results from one of a blasting process and an etching process.

17. The method according to claim 15, wherein the coating layer is formed by applying resin onto the rugged surface of the base member by a spin coat method.
